(19) United States
(12) Patent Application Publication
(10) Pub. No.: US 2007/0188813 A1
(43) Pub. Date: Aug. 16, 2007

(54) Printing apparatus, image processing apparatus, printing method, and image processing method

(76) Inventor: Yoshiyuki Ozawa, Shiojiri-shi (JP)

Correspondence Address: MARTINE PENILLA & GENCARELLA, LLP, 710 LAKEWAY DRIVE, SUITE 200, SUNNYVALE, CA, 94085, US

(21) Appl. No.: 11/655,586

(22) Filed: Jan. 18, 2007

(30) Foreign Application Priority Data
Jan. 18, 2006 (JP) P2006-009580

(51) Int. Cl. G06K 15/00

(52) U.S. Cl. 358/3.21

(57) ABSTRACT

A printing apparatus is operable to print an image by forming first dots with first ink having a first density and second dots with second ink having a second density lower than the first density. A first dot former is operable to form a plurality of sizes of the first dots. A second dot former is operable to form a plurality of sizes of the second dots. A smallest one of the sizes of the first dots is smaller than a smallest one of the sizes of the second dots. A largest one of the sizes of the first dots is larger than a largest one of the sizes of the second dots.

A claim of priority under 35 U.S.C. § 119 is made to Japanese Patent Application No. 2006/009580, filed Jan. 18, 2006, which is incorporated herein by reference in its entirety.

### BACKGROUND

The present invention relates to an art for printing an image on a printing medium using an ink.

As represented by a so-called inkjet printer, a printing apparatus ejects minute ink drops onto a printing medium so as to form dots thereon, thereby printing images. This printing apparatus has been widely used as an image output apparatus. The printing apparatus can obtain only information on whether a dot is formed or not for each pixel. However, by controlling a dot forming density, the printing apparatus can achieve a continuous grayscale expression when the image is viewed far away.

This printing apparatus prints an image using dots. For this reason, if the dots are viewed, image quality is deteriorated. Accordingly, in order to print the image with superior image quality in which the dots are not viewed, various technologies have been developed. For example, a technology has been developed in which in addition to an ink having a general density, an ink having a small density (light ink) is accommodated, at a portion where the dots are easily viewed, the dots are formed by using the light ink, and an image where the dots are not viewed is printed (for example, Japanese Patent Publication No. 10-175318A). Alternatively, a technology has been developed in which dots each having a different dot size are formed, small dots are formed at a portion where dots are easily viewed, and an image where the dots are not viewed is printed (for example, Japanese Patent Publication No. 7-285222). Further, according to these technologies, since the number of grayscales represented by individual pixels can be increased, image quality can be improved.

Further, in recent times, a technology has been suggested in which driving waveforms of nozzles ejecting ink drops are changed, and a large number of types of dots each having a different dot size are formed (for example, Japanese Patent Publication No. 2000-52570). According to this technology, for example, two systems of driving waveforms are changed, and eight types of dots each having a different dot size are formed. In this case, if this technology is combined with a technology in which two types of inks (dark ink and light ink) each having a different density are used, since eight types of dots can be formed by each ink having each density, it is possible to form sixteen types of dots in total. Accordingly, in theory, grayscale variation of 16 stages (17 stages in the case of including a state where a dot is not formed) can be represented by individual pixels, which drastically improves image quality.

However, in a case where the suggested technologies are combined to the technology using the dark ink and the light ink, even though a plurality of types of dots can be formed, it is actually not possible to achieve an image quality improving effect and new problems occur. That is, if the types of the dots that can be formed are increased, the types of the dots are frequently changed according to the grayscale variation, which deteriorates image quality. Therefore, it is not possible to sufficiently improve the image quality. In addition, when the dot types are increased, since an image process performed before the image is printed becomes complicated, it may cause new problems, such as a decrease in a processing speed, or an increase in a memory capacity necessary for image processing. Accordingly, a method has been required in which a plurality of types of dots can be formed without causing the above-described problems.

### SUMMARY

It is therefore an object of the invention to provide a method in which a merit capable of forming a plurality of sizes of dots without causing above mentioned various problems can be sufficiently achieved.

In order to achieve the above described object, according to the invention, there is provided printing apparatus operable to print an image by forming first dots with first ink having a first density and second dots with second ink having a second density lower than the first density, the printing apparatus comprising:

a first dot former operable to form a plurality of sizes of the first dots; and

a second dot former operable to form a plurality of sizes of the second dots, wherein:

a smallest one of the sizes of the first dots is smaller than a smallest one of the sizes of the second dots; and

a largest one of the sizes of the first dots is larger than a largest one of the sizes of the second dots.

The first dot former may be operable to form three sizes of the first dots.

The second dot former may be operable to form three sizes of the second dots.

Each of the sizes of the first dots may be different from each of the sizes of the second dots.

According to the invention, there is also provided an image processing apparatus operable to generate control data adapted to be used in a printing apparatus which is operable to print an image by forming first dots with first ink having a first density and second dots with second ink having a second density lower than the first density, by performing a predetermined image process on image data of the image, the image processing apparatus comprising:

a first dot formation judge operable to judge whether the first dots having one of a plurality of sizes are formed or not, based on the image data;

a second dot formation judge operable to judge whether the second dots having one of a plurality of sizes are formed or not, based on the image data; and

a control data generator operable to generate the control data based on judgments of the first dot formation judge and the second dot formation judge, wherein:

a smallest one of the sizes of the first dots is smaller than a smallest one of the sizes of the second dots; and

a largest one of the sizes of the first dots is larger than a largest one of the sizes of the second dots.

According to the invention, there is also provided a printing method for printing an image by forming first dots with first ink having a first density and second dots with second ink having a second density lower than the first density, the printing method comprising:

forming a plurality of sizes of the first dots; and

forming a plurality of sizes of the second dots, wherein:

a smallest one of the sizes of the first dots is smaller than a smallest one of the sizes of the second dots; and

a largest one of the sizes of the first dots is larger than a largest one of the sizes of the second dots.

According to the invention, there is also provided an image processing method for generating control data adapted to be used in a printing apparatus which is operable to print an image by forming first dots with first ink having a first density and second dots with second ink having a second density lower than the first density, by performing a predetermined image process on image data of the image, the image processing method comprising:

judging whether the first dots having one of a plurality of sizes are formed or not, based on the image data;

judging whether the second dots having one of a plurality of sizes are formed or not, based on the image data; and

generating the control data based on the judging, wherein:

a smallest one of the sizes of the first dots is smaller than a smallest one of the sizes of the second dots; and

a largest one of the sizes of the first dots is larger than a largest one of the sizes of the second dots.

According to the invention, there is also provided program products each of which comprises a recording medium having recorded a program operable to cause a computer to execute the above methods, respectively.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a diagram illustrating an outline of a printing apparatus according to an embodiment of the invention;

FIG. 2 is a perspective view illustrating an outer shape of a printing apparatus according to an embodiment of the invention;

FIG. 3 is a diagram illustrating an aspect where opened is a platen cover provided on a printing apparatus in order to read a document image;

FIG. 4 is a perspective view illustrating an aspect where a scanner unit rotates by raising a front side of the scanner unit;

FIG. 5 is a diagram conceptually illustrating an inner structure of a printing apparatus according to an embodiment of the invention;

FIG. 6 is a diagram illustrating an aspect where a plurality of nozzles for ejecting ink droplets are formed in ink ejecting heads of respective colors;

FIG. 7 is a diagram illustrating a principle of forming ink dots having different sizes by controlling sizes of ejected ink droplets;

FIG. 8 is a diagram illustrating two systems of driving waveforms that are used in a printing apparatus according to an embodiment of the invention;

FIG. 9 is a diagram illustrating an aspect where a printing apparatus according to an embodiment of the invention form a plurality of types of dots by changing driving waveform applied to nozzles;

FIG. 10 is a flowchart illustrating a flow of an image printing process by a printing apparatus according to an embodiment of the invention in order to print an image;

FIG. 11 is a diagram conceptually illustrating a color conversion table used when performing a color converting process;

FIG. 12 is a diagram collectively illustrating types of dots that are determining whether a dot is formed by a halftone process according to an embodiment of the invention;

FIG. 13 is a diagram illustrating an enlarged portion of a dither matrix;

FIG. 14 is a diagram conceptually illustrating an aspect where whether a dot is formed for every pixel on the basis of a dither matrix;

FIG. 15 is a flowchart illustrating a flow of a halftone process that is performed by an image printing apparatus during an image printing process; and

FIG. 16 is a diagram illustrating a forming density table that is used when converting image data into forming density data.

### DETAILED DESCRIPTION OF THE EMBODIMENTS

Hereinafter, an embodiment according to the invention will be discussed with reference to the accompanying drawings and in the following order.

A. Outline of Embodiment:

B. Structure of Apparatus:
B-1. Entire Structure:
B-2. Inner structure:
   B-2-1. Inner structure of Scanner Unit:
   B-2-2. Inner structure of Printer Unit

C. Image Printing Process:

D. Halftone Process of Embodiment:

A. Outline of Embodiment:

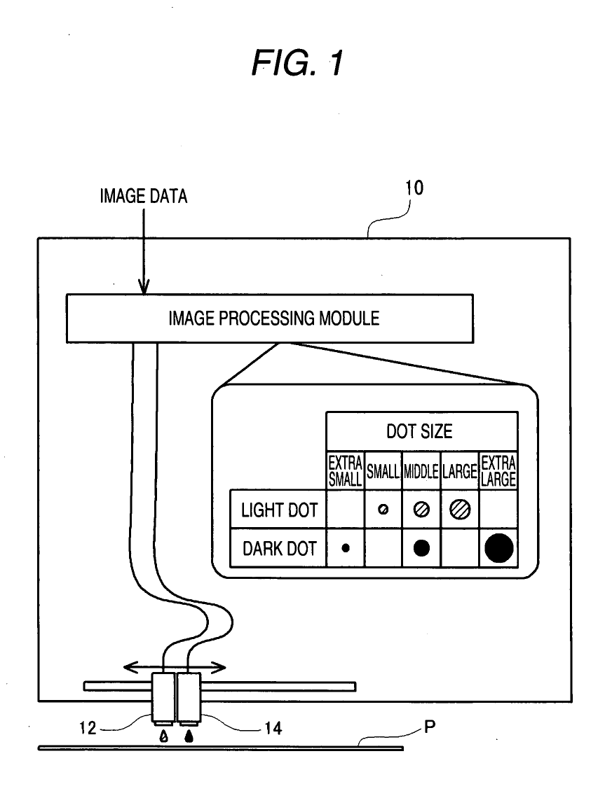

Before an embodiment is described in detail, an outline of the embodiment will be described with reference to FIG. 1. FIG. 1 is a diagram illustrating an outline of a printing apparatus 10 according to an embodiment of the invention. The printing apparatus 10 shown in FIG. 1 includes a printing head 14 that ejects a dark ink and a printing head 12 that ejects a light ink. This printing apparatus 10 is a so-called inkjet printer in which the printing heads 12 and 14 eject ink drops while reciprocating on a printing medium p so as to form an ink dot by a dark ink (dark dot) and an ink dot by a light ink (light dot), thereby printing images.

As shown in the drawing, an image processing module is incorporated in the printing apparatus 10. When image data of an image to be printed is received, the printing apparatus 10 performs a predetermined image process using the image processing module and converts the image data into data that is represented according to whether a dark dot and a light dot are formed or not. Moreover, the ‘module’ means that a series of processes, which are performed in the printing apparatus 10 for the printing apparatus 10 to print images, are classified according to their functions. Accordingly, the ‘module’ can be implemented as a portion of a program, implemented by using a logical circuit having a specific function, or implemented by a combination thereof. In addition, the printing apparatus 10 supplies the data obtained by the image processing module to the printing heads 12 and 14, forms a dark dot and a light dot according to the image processed result, and prints images.

Further, the printing heads 12 and 14 according to this embodiment can eject ink drops each having a different size such that dots each having a different dot size can be formed. In the example shown in FIG. 1, dot sizes can be changed in five stages from a smallest dot to a largest dot. In this case, the dots whose sizes are changed in the five stages are respectively referred to as an ‘extra small dot’, a ‘small dot’, a ‘middle dot’, a ‘large dot’, and an ‘extra large dot’. Since the dot sizes can be changed with respect to each of the dark dot and the light dot, dot sizes can be changed in five stages as for the dark dot and dot sizes can be changed in five stages for the light dot. That is, images can be printed while dot types are changed in ten stages.

However, if there are too many dot types, the dot types are frequently changed in the image, which deteriorates printed image quality. In addition, when the dot types are increased, since an image process performed before the image is printed becomes complicated, it may cause problems, such as a decrease in a processing speed, a decrease in a printing speed due to the decrease in the processing speed, or an increase in a memory capacity necessary for image processing.

Accordingly, the image processing module of the printing apparatus 10 shown in FIG. 1 is set in the following manner. If the image processing module receives image data, the image processing module does not converts the image data into data represented using dots of all types that can be formed, but converts image data using only dots in which an image quality improving effect of a predetermined value or more can be obtained. In FIG. 1, the types of the dots, which the image processing module uses to convert the image data, are collected in a table. As shown in FIG. 1, in regards to the light dot, only three types of dots including the ‘small dot’, the ‘middle dot’, and the ‘large dot’ are used without using the ‘extra small dot’ and the ‘extra large dot’. The ‘extra small dot’ and the ‘extra large dot’ are used only in the dark dot. Further, in regards to the dark dot, according to the fact that only the three kinds of dots are used in regards to the light dot, one type of dot (here, middle dot) is added to the ‘extra small dot’ and the ‘extra large dot’, and the three types of dots are used. Accordingly, in the image processing module shown in FIG. 1, the dots of the three types including the ‘small dot’, the ‘middle dot’, and the ‘large dot’ are used in regards to the light dot and the dots of the three types including the ‘extra small dot’, the ‘middle dot’, and the ‘extra large dot’ are used in regards to the dark dot. That is, the image data is converted using the dots of the six types in total. The data that has been converted in this way is supplied to the printing heads 12 and 14, and the ink drop of the light ink is ejected from the printing head 12 and the ink drop of the dark ink is ejected from the printing head 14. As a result, an image is printed on the printing medium P.

In general, the dot by the light ink is viewed less than the dot by the dark ink, and when the size of the dot is decreased, the dot is less viewed. The ‘extra small dot’ of the light dots becomes a dot that is least viewed. As a result, it is assumed that if the above-described dots are formed, image quality can be drastically improved. In actual, there are not so many images whose printing image quality can be sufficiently improved using the dots that are difficult to be viewed. Accordingly, in most of cases, even if the ‘extra small dot’ of the light dots can be formed, a large image quality improving effect is not obtained. Further, since the largest dot (in this case, extra large dot) is exclusively used when printing a painting-out image referred to as a so-called solid image, a character, or the like, the light dots are rarely used. Accordingly, if the image data is converted while the light dots are excluded, the types of the dots can be effectively reduced. In addition, if the types of each of the light dot and the dark dot are set to the three types, a dot size of any dot can be represented as two bits. When a plurality of types of dots are used, it is possible to reduce an amount of data that is obtained as the result of image processing. As a result, it is possible to prevent problems from occurring due to the fact that the types of the dots are frequently changed so as to cause image quality to be deteriorated, or the image process becomes complicated so as to cause a decrease in a processing speed or an increase in a memory capacity necessary for image processing. In the description below, this printing apparatus 10 will be described in detail with reference to embodiments.

B. Structure of Apparatus:

B-1. Entire Structure:

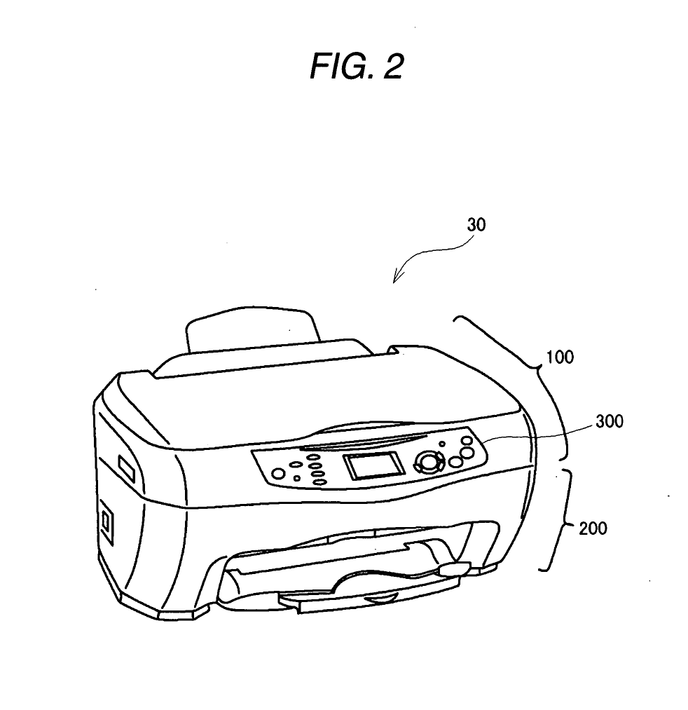

FIG. 2 is a perspective view illustrating an outer shape of a printing apparatus 10 according to an embodiment of the invention. As shown in FIG. 2, the printing apparatus 10 according to this embodiment includes a scanner unit 100, a printer unit 200, and an operational panel 300 that sets an operation of the scanner unit 100 and the printer unit 200. The scanner unit 100 has a function as a scanner that reads out the printed image and creates image data, and the printer unit 200 has a function as a printer that receives the image data and prints the image on the printing medium. Further, if the image (document image) read by the scanner unit 100 is output through the printer unit 200, a copy function can also be realized. That is, the printing apparatus 10 according to this embodiment becomes a so-called scanner/printer/copy machine composite apparatus (hereinafter, referred to as SPC composite apparatus) that can independently achieve a scanner function, a printer function, and a copy function.

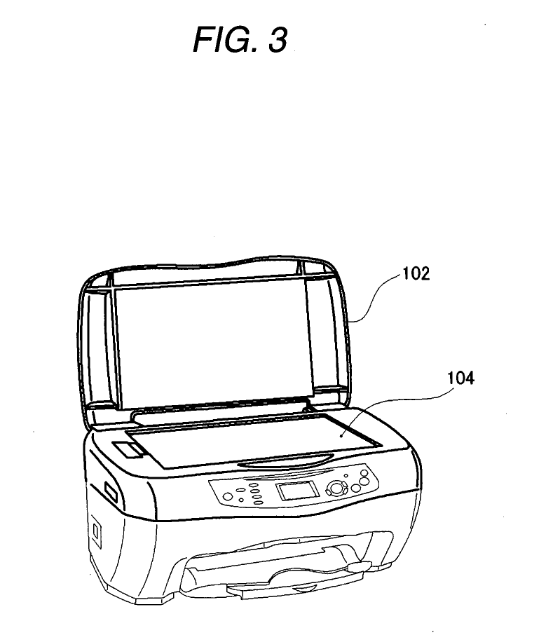

FIG. 3 is a diagram illustrating an aspect where opened is a platen cover 102 provided on a printing apparatus 10 in order to read a document image in order to read a document image. As shown in FIG. 3, if the plate cover 102 is opened upward, a transparent platen glass 104 is provided, and various mechanisms (described below) for achieving a scanner function are mounted therein. When the document image is read, as shown in FIG. 3, first, the platen cover 102 is opened, the document image is placed on the platen glass 104, the platen cover 102 is closed, and a button provided on the operational panel 300 is operated. In this way, it is possible to immediately convert the document image into image data.

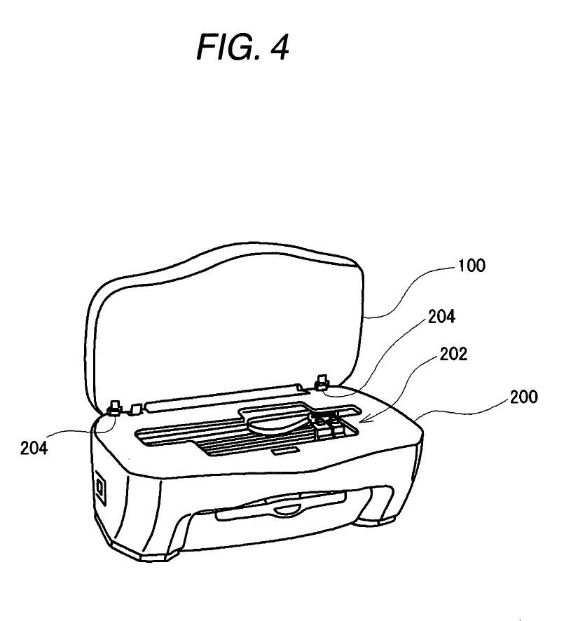

Further, the scanner unit 100 has a structure in which the entire scanner unit 100 is accommodated in an integral case. The scanner unit 100 and the printer unit 200 are coupled with each other by a hinge mechanism 204 (refer to FIG. 4) at the rear surface side of the printing apparatus 10. For this reason, when the front side of the scanner unit 100 is raised, only the scanner unit 100 can be rotated at a portion of the hinge mechanism.

FIG. 4 is a perspective view illustrating an aspect when the front side of the scanner unit 100 is raised and rotated. As shown in FIG. 4, in the printing apparatus 10 according to this embodiment, when the front side of the scanner unit 100 is raised, a top surface of the printer unit 200 can be exposed to the outside. In the printer unit 200, various mechanisms (described below) for achieving a printer function, a control circuit 260 (described below) for controlling a whole operation of the printing apparatus 10 including the scanner unit 100, a power supply circuit (not shown) for supplying power to the scanner unit 100 or the printer unit 200, and the like are provided. Further, as shown in FIG. 4, an opening 202 is provided in the top surface of the printer unit 200, such that exchange of consumption articles, such as an ink cartridge, processing of paper jam, and other slight repairs can be easily performed.

B-2. Inner Structure:

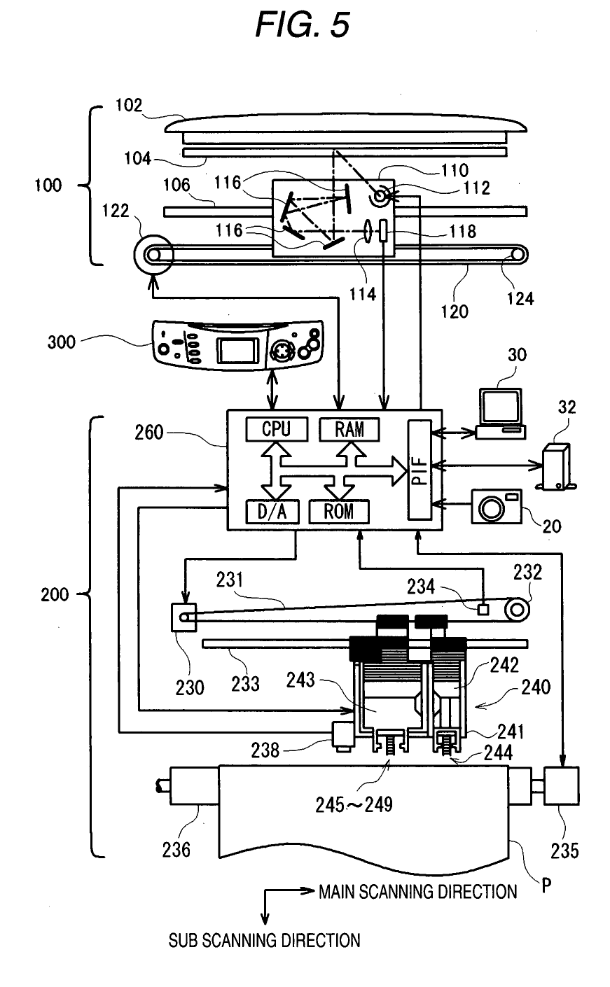

FIG. 5 is a diagram conceptually illustrating an inner structure of a printing apparatus 10 according to an embodiment of the invention. As described above, in the printing apparatus 10, the scanner unit 100 and the printer unit 200 are provided, various mechanisms for achieving the scanner function are mounted in the scanner unit 100, and various mechanisms for achieving the printer function are mounted in the printer unit 200. Hereinafter, first, the inner structure of the scanner unit 100 will be omitted and then the inner structure of the printer unit 200 will be described.

B-2-1. Inner Structure of Scanner Unit:

The scanner unit 100 includes a transparent platen glass 104 that sets the document images, a platen cover 102 that presses the set document images, a read carriage 110 that reads out the set document images, a driving belt 120 that moves the read carriage 110 in a read direction (main scanning direction), a driving motor 122 that supplies power to the driving belt 120, and a guide shaft 106 that guides motion of the read carriage 110. Further, the operation of the driving motor 122 or the read carriage 110 is controlled by the control circuit 260 to be described below.

If the driving motor 122 rotates under a control of the control circuit 260, the motion of the driving motor 122 is transmitted to the read carriage 110 through the driving belt 120. As a result, the read carriage 110 moves in a read direction (main scanning direction) according to a rotational angle of the driving motor 122 while being guided to a guide shaft 106. Further, the driving belt 120 is continuously adjusted in an appropriately extended state by means of an idler pulley 124. For this reason, if the driving motor 122 inversely rotates, the read carriage 110 can move in a reverse direction by the distance according to a rotational angle.

In the read carriage 110, a light source 112, a lens 114, a mirror 116, a CCD sensor 118, and the like are mounted. Light emitted from the light source 112 is radiated onto the platen glass 104 and is reflected on the document image that is set on the platen glass 104. The reflected light is guide to the lens 114 by the mirror 116, is condensed by the lens 114, and is detected by the CCD sensor 118. The CCD sensor 118 is composed of a linear sensor in which photodiodes that convert the intensity of the light into an electrical signal are disposed in a columnar shape in a direction perpendicular to a moving direction (main scanning direction) of the read carriage 110. For this reason, the light emitted from the light source 112 is radiated onto the document image while read carriage 110 is moved in a main scanning direction, and the intensity of the reflected light is detected by the CCD sensor 118, which obtains an electrical signal according to the document image.

Further, the light source 112 is composed of light emitting diodes for three primary colors including R (red), G (green), and B (blue). The light source 112 can sequentially radiate R light, G light, and B light. As a result, in the CCD sensor 118, the R reflected light, the G reflected light, and the B reflected light can be sequentially detected. In generally, a red portion of an image reflects the R light, but does not reflect the G light or the B light. Therefore, the R reflected light displays an R component of the image. Similarly, the G reflected light displays a G component of the image and the B reflected light displays a B component of the image. Accordingly, the light of the three primary colors including R, G, and B are radiated onto the document image while being changed with a predetermined cycle, and at the same time, the intensity of the reflected light is detected by the CCD sensor 118. In this case, the R component, the G component, and the B component of the document image can be detected and the color image can be read out. Further, since the read carriage 110 moves while the color of the light which the light source 112 radiates is changed, the locations of the image where the respective components of R, G, and B are detected are different by a degree corresponding to a movement amount of the read carriage 110, but the positional deviation can be corrected by image processing after the respective components are read out.

B-2-2. Inner Structure of Printer:

Next, an inner structure of the printer unit 200 will be described. The printer unit 200 includes a control circuit 260 that controls a whole operation of the printing apparatus 10, a printing carriage 240 that prints an image on a printing medium, a mechanism that moves the printing carriage 240 in a main scanning direction, a mechanism that performs a paper feeding operation for the printing medium, and the like.

The printing carriage 240 includes an ink cartridge 242 that accommodates a K ink, an ink cartridge 243 that accommodates various inks including a C ink, a light C ink (LC ink), an M ink, a light M ink (LM ink), and a Y ink, a printing head 241 that is provided on a side of a bottom surface of the printing carriage 240, and the like. In the printing head 241, ink ejecting heads for ejecting ink drops are provided for every ink. If the ink cartridges 242 and 243 are mounted in the printing carriage 240, the respective inks in the cartridges are supplied to ink ejecting heads 244 to 249 of the respective colors through an introducing tube (>not shown).

The mechanism that moves the printing carriage 240 in a main scanning direction includes a carriage belt 231 that drives the printing carriage 240, a carriage motor 230 that supplies power to the carriage belt 231, an extension pulley 232 that continuously applies appropriate extension to the carriage belt 231, a carriage guide 233 that guides the motion of the printing carriage 240, and an original point location detecting sensor 234 that detects the original point location of the printing carriage 240. If the carriage motor 230 rotates under a control of the control circuit 260 to be described below, the printing carriage 240 can move in a main scanning direction by a distance corresponding to the rotational angle. If the carriage motor 230 inversely rotates, the printing carriage 240 can move in a reverse direction.

Further, in the printing apparatus 10 according to this embodiment, an optical detecting sensor 238 is provided on a side of the printing carriage 240, and detects the characteristic of the printed surface of the printing medium and supplies it to the control circuit 260.

The mechanism that performs a paper feeding operation for the printing medium includes a platen 236 that supports the printing medium from the rear surface side and a paper feeding motor 235 that rotates the platen 236 and performs a paper feeding operation. If the paper feeding motor 235 rotates under a control of the control circuit 260 to be described below, the printing medium can move in a sub scanning direction by a distance according to a rotational angle.

The control circuit 260 includes a CPU, a ROM or a RAM, a D/A converter that converts digital data into an analog signal, a peripheral apparatus interface PIF that performs a data exchange with peripheral apparatuses, and the like. The control circuit 260 controls the whole operation of the printing apparatus 10, and controls the operation of the light source 112, the driving motor 122, and the CCD sensor 118 mounted in the scanner unit 100 while exchanging data with them.

Further, the control circuit 260 drives the carriage motor 230 and the paper feeding motor 235 to perform a main scanning operation and a sub scanning operation of the printing carriage 240, and at the same time, performs a control for supplying driving signals to the ink ejecting heads 244 to 249 of the respective colors to eject ink drops. The driving signals that are supplied to the ink ejecting heads 244 to 249 are generated by reading out the image data from a computer 30, a digital camera 20, and an external storage device 32 and performing an image process to be described below on the read image data. Alternatively, an image process is performed on the image data read by the scanner unit 100 so as to generate a driving signal. In this way, while the main scanning operation and the sub scanning operation of the printing carriage 240 are performed under a control of the control circuit 260, the ink drops are ejected from the ink ejecting heads 244 to 249 so as to form ink dots of respective colors on the printing medium, thereby printing a color image. Alternatively, instead of performing the image process in the control circuit 260, the data having subjected to the image process may be received from the computer 30, and the ink ejecting heads 244 to 249 may be driven while the main scanning operation and the sub scanning operation of the printing carriage 240 are performed according to the received data.

Further, the control circuit 260 is also connected to the operational panel 300 such that it can exchange data with the operational panel 300. When operating various buttons provided on the operational panel 300, a detailed operation mode of the scanner function or the printer function can be set. Further, the detailed operation mode can be set from the computer 30 through the peripheral apparatus interface PIF.

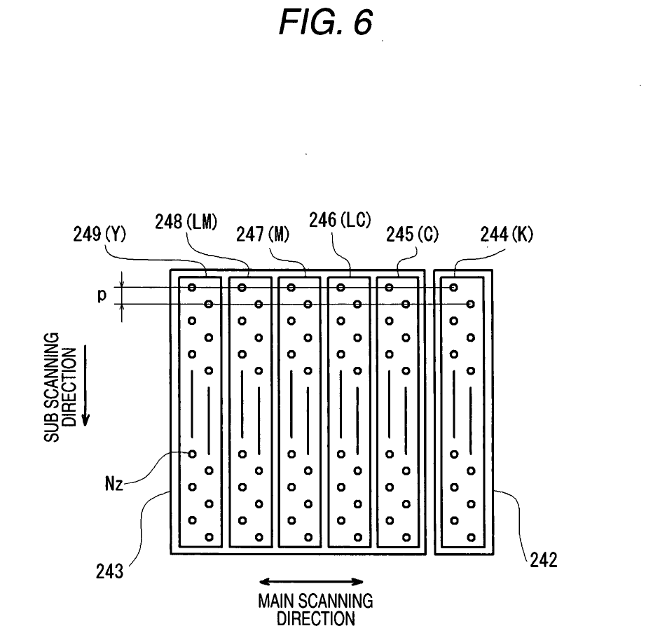

FIG. 6 is a diagram illustrating an aspect where a plurality of nozzles Nz for ejecting ink droplets are formed in ink ejecting heads 244 to 249 of respective colors. As shown in FIG. 6, six sets of nozzle columns for ejecting ink drops of the respective colors are formed in bottom surfaces of the ink ejecting heads of the respective colors. In one set of nozzle column, 48 nozzles Nz are arranged in zigzag at an interval of a nozzle pitch k. Each of the nozzles Nz is supplied with a driving signal from the control circuit 260 and ejects an ink drop by using each ink in accordance with the driving signal.

Further, the printing apparatus 10 according to this embodiment controls a size of an ejected ink drop, thereby forming dots each having a different size on the printing medium. The principle of forming the dots having the different sizes will now be described.

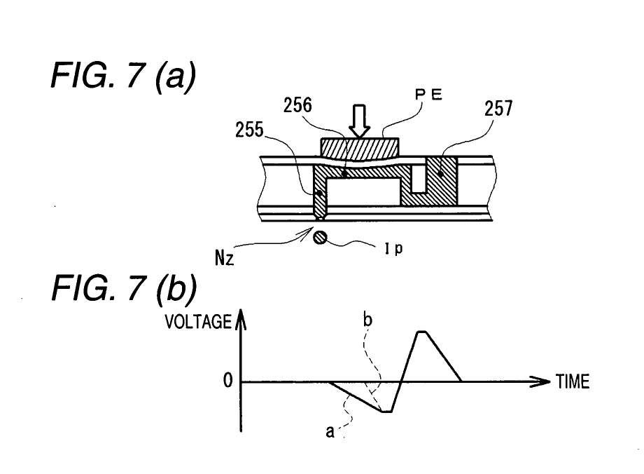

FIGS. 7(a) and 7(b) are diagrams illustrating a principle of forming ink dots having different sizes by controlling sizes of ejected ink drops. FIG. 7(a) is a diagram illustrating an inner structure of a nozzle for ejecting an ink drop and a method of ejecting the ink drop. In each of the ink ejecting heads 244 to 249 for respective colors, a plurality of nozzles are provided. As shown in FIG. 7(a), in each nozzle, an ink passage 255 and an ink chamber 256 are provided. A piezoelectric element PE is provided on a top surface of the ink chamber. If the ink cartridges 242 and 243 are mounted in the carriage 240, the ink in each cartridge is supplied to the ink chamber 256 through an ink gallery 257.

As well known, the piezoelectric element PE is an element in which when a voltage is applied to the element, its crystal structure is distorted, and an electro-mechanical energy conversion is performed at a high speed. In this embodiment, a voltage having a predetermined waveform is applied between electrodes provided at both ends of the piezoelectric element PE to thus deform sidewalls of the ink chamber 256. As a result, a volume of the ink chamber 256 is decreased, and an ink corresponding to the reduced volume becomes an ink drop Ip to be ejected from the nozzles Nz. The ink drop Ip is soaked into the printing paper P that is mounted in the platen 236, and thus ink dots are formed on the printing paper.

FIG. 7(b) is a diagram illustrating a principle of changing a size of an ejected ink drop by controlling a waveform of a voltage applied to the piezoelectric element PE. In order to eject the ink drops Ip from the nozzles, a negative voltage is applied to the piezoelectric element PE, and an ink is absorbed in the ink chamber 256 from the ink gallery 257. Then, a positive voltage is applied to the piezoelectric element PE so as to decrease the volume of the ink chamber, thereby ejecting the ink drop Ip. In this case, if an ink absorbing speed is appropriate, an ink that corresponds to a variation in the volume of the ink chamber is absorbed. However, if the ink absorbing speed is excessively fast, since passage resistance exists between the ink gallery 257 and the ink chamber 256, the inflow of the ink from the ink gallery 257 is delayed. As a result, the ink of the ink passage 255 flows backward in the ink chamber, and thus the ink interface near the nozzles retreats by a large amount. A voltage waveform a that is shown by a solid in FIG. 7(b) indicates a waveform of when an ink is absorbed at an appropriate speed, and a voltage waveform b that is shown by a broken line indicates an example of a waveform of when an ink is absorbed at a speed larger than the appropriated speed.

In a state where a sufficient amount of ink is supplied to the ink chamber 256, if a positive voltage is applied to the piezoelectric element PE, the ink drop Ip having a volume that corresponds to the decrease in the volume of the ink chamber 256 is ejected from the nozzles Nz. In contrast, in a state where an amount of supplied ink is insufficient and the ink interface retreats by a large amount, a positive voltage is applied, and the ejected ink drop becomes a small ink drop. Further, the size of the ejected ink drop varies depending on the magnitude of the applied positive voltage. For example, even when the sufficient amount of ink is absorbed in the ink chamber 256, if the positive voltage to be applied is small, the ink drop to be ejected becomes smaller. As such, the printer unit 200 that is mounted in the printing apparatus 10 according to this embodiment controls a waveform of a voltage applied at the time of ejecting the ink drop so as to control a size of the ink drop to be ejected. Therefore, it becomes possible to form dots each having a different size.

Further, in the printing apparatus 10 according to this embodiment, two systems of voltage waveforms, which can cause ink dots of two types (small and large) to be ejected, are prepared, and the dots are formed while these driving waveforms are changed, which forms ink dots having a large number of types of sizes (five types in this embodiment). Hereinafter, a method of forming a plurality of types of dots having different sizes by using the two systems of driving waveforms while changing the driving waveforms will be described.

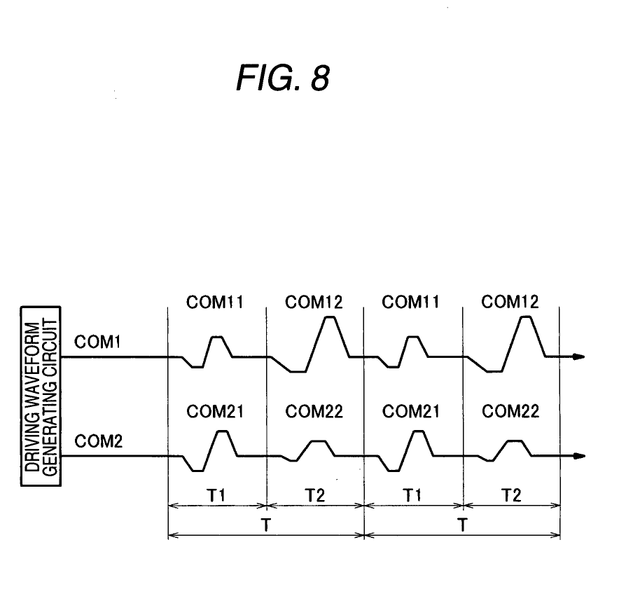

FIG. 8 is a diagram illustrating the two systems of driving waveforms that are used in the printing apparatus 10 according to this embodiment. In the control circuit 260, a driving waveform generating circuit (not shown) is mounted, and the two systems of driving waveforms including a waveform COM1 and a waveform COM2 are output from the driving waveform generating circuit. However, instead of mounting the driving waveform generating circuit in the control circuit 260, digital data of the driving waveforms may be stored in a ROM, and a waveform of the digital data may be converted into an analog waveform by the D/A converter so as to be output as the driving waveform.

As shown in FIG. 8, each system of driving waveform becomes a waveform from which two types of driving waveforms are repeatedly output. For example, the driving waveform COM1 includes a driving waveform COM11 that causes a small ink drop to be ejected and a driving waveform COM12 that causes a large ink drop to be ejected, and becomes a waveform from which these two types of waveforms are repeatedly output with a cycle T. Similar to the driving waveform COM1, the driving waveform COM2 becomes a waveform from which two waveforms including a waveform COM21 and a waveform COM22 are repeatedly output with the same cycle T. According to the sizes of the ink drops ejected depending on the respective waveforms, the size of the ink drop ejected depending on the waveform COM22 is smallest, the sizes of the ink drops ejected depending on the waveforms COM11 and COM21 are second smallest, and the size of the ink dot ejected depending on the waveform COM12 is largest. The two systems of driving waveforms are simultaneously supplied to the respective nozzles that are mounted in the ink ejecting heads 244 to 249 according to this embodiment, and it is possible to change a driving waveform applied to the piezoelectric element PE at the nozzle side. By using this structure, a plurality of types of dots can be formed as follows.

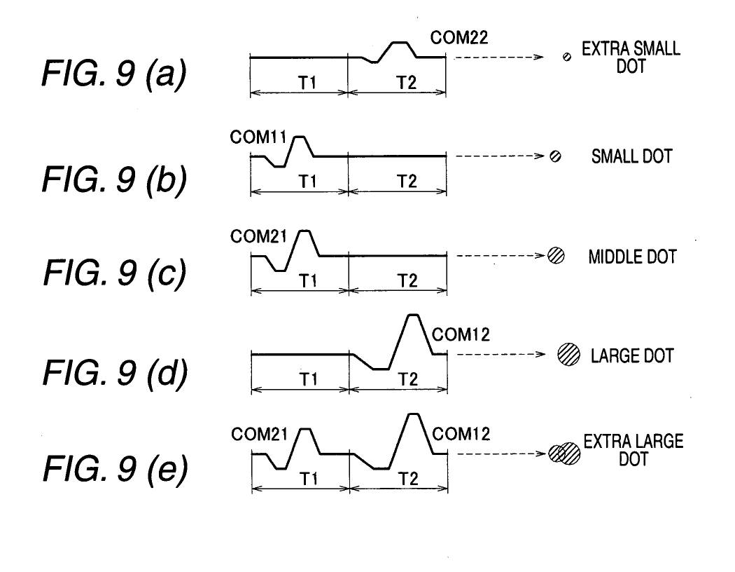

FIGS. 9(a) to 9(e) are diagrams illustrating an aspect where a printing apparatus 10 according to an embodiment of the invention form a plurality of types of dots by changing driving waveforms applied to nozzles. Since the sizes of the dots are changed in five stages in the printing apparatus 10 according to this embodiment, if necessary, the dots are discriminated as the ‘extra small dot’, the ‘small dot’, the ‘middle dot’, the ‘large dot’, and the ‘extra large dot’ in the order of smaller dots. When the ‘extra small dot’ is formed, as shown in FIG. 9(a), the waveform COM22, which causes an smallest ink drop to be ejected, is applied to the nozzles. As described above, since each of the two systems of driving waveforms COM1 and COM2 is supplied with the cycle T, if the driving waveform COM2 is applied to the nozzles by a period corresponding to the second half T2 of the cycle T, the nozzles can be driven by using the driving waveform COM22.

When the ‘small dot’ is formed, the nozzles may be driven by using the driving waveform COM11 that causes the second smallest ink drop to be ejected, as shown in FIG. 9(b). If the driving waveform COM1 is applied to the nozzles by the period corresponding to the first half T1 of the cycle T, the nozzles can be driven by using the driving waveform COM11. Similarly, when the ‘middle dot’ is formed, the nozzles are driven by using the driving waveform COM21 that causes the next large ink drop to be ejected, and when the ‘large dot’ is formed, the nozzles are driven by using the driving waveform COM12 that causes the largest ink drop to be ejected. Further, when the ‘extra large dot’ is formed, the waveform COM12 subsequent to the waveform COM21 is continuously applied to the nozzles, as shown in FIG. 9(e). If the driving waveform COM2 is supplied to the nozzles in the first half T1 of the cycle T and the driving waveform COM1 is applied to the nozzles in the second half T2 of the cycle T, the waveform COM12 sequent to the waveform COM21 can be continuously applied to the nozzles, as shown in FIG. 9(e). In this way, if the two waveforms are applied, two dots (in this case, a middle dot and a large dot) are formed on the recording medium with a slight positional deviation, and thus the extra large dot can be formed. In the printing apparatus 10 according to this embodiment, the waveforms that are applied to the nozzles are changed, such that the five types of dots, each having a different dot size, are formed.

As can be understood from the above-described description, it is possible to form dots of more than the five types. For example, if the two driving waveforms including the driving waveform COM11 and the driving waveform COM12 are supplied, it is possible to form a dot slightly larger than the large dot, and if the driving waveform COM21 and the driving waveform COM22 are supplied, it is possible to form a dot slightly larger than the middle dot. Further, the driving waveform COM11 and the driving waveform COM22 are supplied to form dots. Since each of the driving waveform COM11 and the driving waveform COM21 is output in the first half of the cycle T, it is not possible to supply a combination of these two waveforms to the nozzles. Similarly, since the driving waveform COM12 and the driving waveform COM22 are also supplied in the second half of the cycle T, it is not possible to supply a combination of these two waveforms to the nozzles. After all, the two systems of driving waveform shown in FIG. 8 are supplied to the nozzles while the driving waveforms are changed, the sizes of the dots to be formed can be changed in an eight stages to the maximum, in addition to the five stages shown in FIGS. 9(a) to 9(e). In the printing apparatus 10 according to this embodiment, among the eight types of dots, five types of dots, which have a large image quality improving effect, are selectively used. However, the dots having different dot sizes may be used, or the types of the dots may be increased, if necessary.

Further, in the above description, as shown in FIGS. 8 and 9(a) to 9(e), the two systems of driving waveforms including the driving waveform COM1 and the driving waveform COM2 are prepared, a combination of portions of the respective driving waveforms is used, and a plurality of types of dots are formed. However, the driving waveform COM1 and the driving waveform COM2 are not necessarily different from each other, but may be the same. For example, one type of driving waveform by which three types of dots including the small dot, the middle dot, and the large dot can be formed is prepared, and the same driving waveform is supplied in two systems. In addition, like a combination of the small dot and the middle dot, a combination of the small and the large dot, or a combination of the middle dot and the large dot, a combination of some dots is formed. As a result, even when the same driving waveform is used, a plurality of types of dots can be formed.

As described above, the printer unit 200 of the printing apparatus 10 changes the driving waveform supplied to the nozzles, and forms the dots while ejecting the ink drops having different sizes. Further, the control data that changes the driving waveform is created by performing a predetermined image process on the image data before printing the images. A process (image printing process) will be described in which the image process is performed on the image data so as to create control data, and the ink dots are formed on the basis of the obtained control data so as to print the images.

C. Image Printing Process:

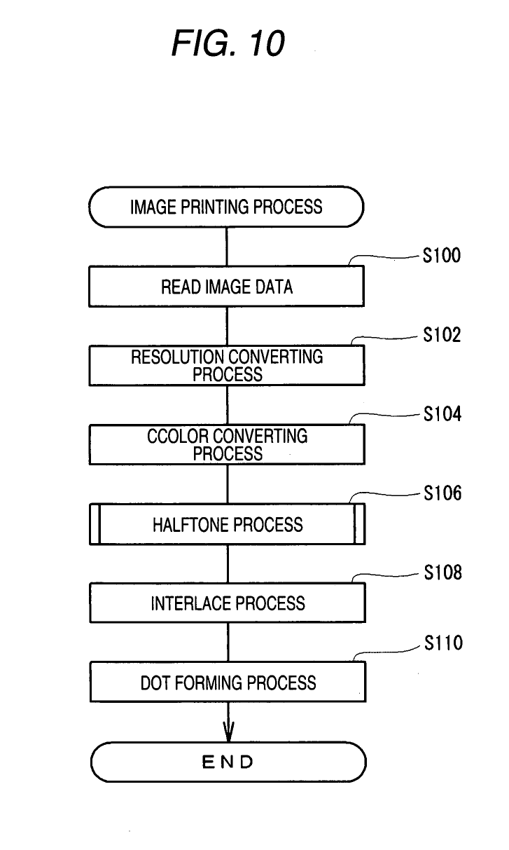

FIG. 10 is a flowchart illustrating a flow of an image printing process by a printing apparatus 10 according to an embodiment of the invention in order to print an image. This process is a process which the control circuit 260 mounted in the printing apparatus 10 performs using the incorporated CPU, RAM, and ROM. Hereinafter, the flowchart will be described.

If the image printing process starts, first, the control circuit 260 reads out image data to be printed (Step S100). In this case, the image data is RGB image data that is represented by grayscale values of the respective colors including R, G, and B.

Next, the control circuit 260 performs a process for converting a resolution of the read image data into a resolution for printing by the printing unit 200 (printing resolution) (Step S102). When the resolution of the read image data is lower than the printing resolution, an interpolation operation is performed among neighboring pixels so as to set new image data, thereby converting the resolution into a high resolution. In contrast, if the resolution of the read image data is higher than the printing resolution, the image data is interpolated from among the neighboring pixels with a predetermined ratio, thereby converting the resolution into a low resolution. In the resolution converting process, the following process is performed. That is, in this process, image data is created or interpolated with a predetermined ratio with respect to the read image data and the read resolution is converted into the printing resolution.

In this way, if the resolution of the image data is converted into the printing resolution, the control circuit 260 performs a color converting process on the image data (Step S104). In this case, the color converting process means a process for converting the image data represented by the respective colors including R, G, and B into image data represented by grayscale values of the respective colors including C, M, Y, and K. The color converting process is performed by using a numerical table that is referred to as a color conversion table (LUT).

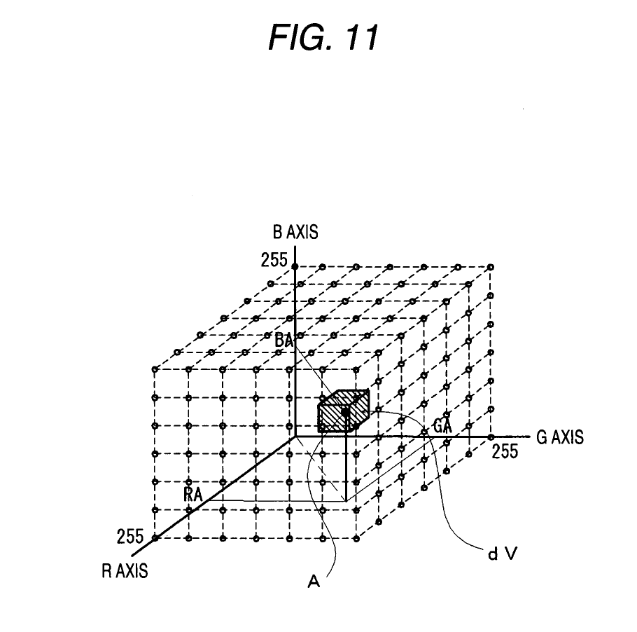

FIG. 11 is a diagram conceptually illustrating a color conversion table (LUT) used when performing a color converting process. It is assumed that the grays-scale values of the respective colors including R, G, and B have values in a range of 0 to 255. Further, as shown in FIG. 11, when considering a color space where the grays-scale values of the respective colors including R, G, and B are obtained in three axes orthogonal to one another, all of the RGB image data can be associated with points inside a cube (color solid) in which the length of one side is 255 while using the original point as the vertex. In another aspect, it may be considered as follows. That is, if the color solid is fractionalized and in a lattice at a right angle with respect to the respective R, G, and B axes and a plurality of lattice points are generated in the color space, the RGB image data corresponding to the respective lattice points exists. A combination of grayscale values of C, M, Y, and K is stored in advance in the respective lattice points. In this case, when the grayscale values stored in the respective lattice points are read out, it is possible to fast convert the RGB image data into image data (CMYK image data) represented by the grayscale values of the respective colors.

For example, If an R component of the image data is set to RA, a G component thereof is set to GA, and a B component thereof is set to BA, the image data is associated with an A point in the color space (see FIG. 11). Accordingly, from among small cubes obtained by fractionalizing the color solid in a lattice, a cube dV including the A point is detected, and the grayscale values of the respective colors including CMYK that are stored in the respective lattice points of the cube dV are read. In addition, if an interpolation operation is performed from the grayscale values of the respective lattice points, the grayscale value at the A point can be calculated. As described above, the color conversion table LUT can be considered as a three-dimensional numerical table in which combinations of the grayscale values of the respective colors including C, M, Y, and K (CMYK image data) are stored in the respective lattice points shown by combining the grayscale values of the respective colors including R, G, and B. If using the color conversion table, it is possible to fast color-convert the RGB image data into the CMYK image data.

When the above-described color converting process is completed, the control circuit 260 starts a halftone process, as shown in FIG. 10 (Step S106). The halftone process is as follows. The CMYK image data that is obtained by the color converting process is image data that is represented in a range of grayscale values of 0 to 255 for each color of C, M, Y, and K. Meanwhile, since the printer unit 200 prints the image by forming the dots, a process is required for converting the CMYK image data represented by 256 grayscale values into image data (dot data) represented according to whether a dot is formed or not. The halftone process means a process for converting the image data of the respective colors including C, M, Y, and K into the dot data.

For a method of performing the halftone process, various methods, such as an error spread method or a dither method, can be used. The error spread method is a method in which it is determined with respect to an arbitrary pixel whether a dot is formed or not, an error in the grayscale expression occurring in the corresponding pixel spreads to neighboring pixels, and it is determined for each pixel whether a dot is formed or not, such that that the error having spread to the neighboring pixels is resolved. The dither method is a method in which a threshold value randomly set in a dither matrix is compared with the image data of the respective colors including C, M, Y, and K for each pixel, and it is determined in the pixel having a large capacity of image data that a dot is formed while it is determined in the pixel having a large threshold value that a dot is not formed, thereby obtaining dot data for each pixel. As the halftone method, any one of the error spread method and the dither method can be used. However, in the printing apparatus 10 according to this embodiment, it is assumed that the halftone process is performed using the dither method.

Further, as described above, in the printing apparatus 10 according to this embodiment, the two systems of driving waveforms are changed and thus the sizes of the dots to be formed can be changed in five stages. In addition, in regards to the C ink and the M ink, the LC ink and the LM ink of the light color are accommodated, and in addition to the changing of the dot sizes, the ink is changed to the light ink, thereby forming dots. Therefore, in regards to the C and M dots, with respect to the dots of ten types including the light and dark dots, a process (halftone process) is required for determining whether a dot is formed or not. However, if the halftone process is performed with respect to the all of the dots, an image process becomes complicated, which causes an increase in a processing speed or an increase in a necessary memory capacity. Further, the sufficient image quality improving effect cannot be obtained in terms of image quality, which causes problems. Accordingly, in the halftone process according to this embodiment, instead of forming the dots of all types, only dots of types where the image quality can be effectively improved are targeted, and it is determined only with respect to the targeted dots whether a dot is formed or not.

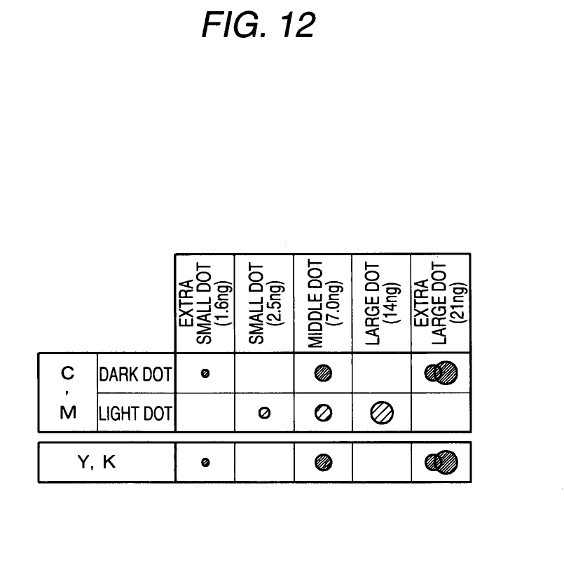

FIG. 12 is a diagram collectively illustrating types of dots that are determining whether a dot is formed by a halftone process according to an embodiment of the invention. With respect to the image data of the C color and the M color that are obtained by the color converting process, a dark dot and a light dot can be formed. In regards to the dark dots, it is determined whether the respective dots including the ‘extra small dot’, the ‘middle dot’, and the ‘extra large dot’ are formed or not. In regards to the light dots, it is determined whether the respective dots including the ‘small dot’, the ‘middle dot’, and the ‘large dot’ are formed or not. Further, with respect to the image data of the Y color and the K color that is obtained by the color converting process, it is determined whether the respective dots including the ‘extra small dot’, the ‘middle dot’, and the ‘extra large dot’ are formed or not. That is, since it is determined only with respect to these dots whether a dot is formed or not, it is possible to obtain a sufficient image quality improving effect without making the process complicated. The reason why the sufficient image quality improving effect can be obtained and the detailed contents of the halftone process will be described in detail below.

In the image printing process shown in FIG. 10, if the halftone process is performed to create dot data for the respective colors including C, M, Y, and K, an interlace process starts (Step S108). The interlace process means a process in which dot data is rearranged according to a dot forming order by the printing head 241 and is then supplied to the ink ejecting heads 244 to 249 of the respective colors. That is, as shown in FIG. 6, the nozzles Nz, which are provided in the ink ejecting heads 244 to 249, are disposed in a sub scanning direction at an interval of a nozzle pitch k. If the ink drops are ejected while main scanning is performed on the printing carriage 240, the dots may be formed in a sub scanning direction at an interval of a nozzle pitch k. Accordingly, in order to form dots in all pixels, it is required that relative positions between the printing carriage 240 and the printing medium are shifted in a sub scanning direction, an new dots are formed in the pixels between the dots spaced apart from one another by the nozzle pitch k. As such, when the image is actually printed, dots are not formed on the image sequentially from the upper pixels. Further, with respect to the pixel existing in the same column in a main scanning direction, a method is widely performed in which the dot is not formed by one-time main scanning, and as the forming of the dot by dividing the one-time main scanning into a plurality of times of main scanning in terms of image quality, the dot is formed in the pixels at positions at intervals.

For this reason, before actually starting the forming of the dot, a process is required for rearranging the dot data obtained for the respective colors including C, M, Y, and K according to the dot forming order of the ink ejecting heads 244 to 249. This process corresponds to the interlace process.

As shown in FIG. 10, if the interlace process is completed, in accordance with the dot data rearranged by the interlace process, a process (dot forming process) for actually forming the dot on the printing medium starts (Step S110). That is, while the main scanning is performed on the printing carriage 240 by driving the carriage motor 230, the rearranged dot data is supplied to the ink ejecting heads 244 to 249. As described above, the dot data is data that indicates whether the respective dots including the ‘extra small dot’, the ‘small dot’, the ‘middle dot’, the ‘large dot’, and the ‘extra large dot’ are formed or not, for each pixel. As described above with reference to FIG. 9, with respect to the pixel forming the ‘extra small dot’, the driving waveform COM22 is only supplied to the nozzles (see FIG. 9(a)), with respect to the pixel forming the ‘small dot’, the driving waveform COM11 is only supplied (see FIG. 9(b), with respect to the pixel forming the ‘middle dot’, the driving waveform COM21 is only supplied (see FIG. 9(c), with respect to the pixel forming the ‘large dot’, the driving waveform COM12 is only supplied (see FIG. 9(a), and with respect to the pixel forming the ‘extra large dot’, the driving waveforms COM21 and the driving waveform COM12 are supplied. As a result, from the ink ejecting heads 244 to 249, the ink drops are ejected in accordance with the dot data, and the dot is appropriately formed in each pixel.

In addition, if the one-time main scanning is completed, the paper feeding motor 235 is driven, and the printing medium is moved in a sub scanning direction. After while the main scanning is formed on the printing carriage 240 by driving the carriage motor 230, the rearranged dot data is supplied to the ink ejecting heads 244 to 249 so as to form dots. By repeatedly performing this operation, on the printing medium, the dots of the respective colors including C (LC), M (LM), Y, and K are appropriately distributed according to the grayscale values of the image data. As a result, the image is printed on the printing medium.

Further, as described above, in the halftone process, the dots, which are capable of effectively image quality, are targeted, and it is determined only with respect to the targeted dot whether a dot is formed or not. Therefore, it is possible to fast print a high-resolution image without making the process complicated. Hereinafter, the halftone process that is performed during the above-described image printing process will be described in detail.

D. Halftone Process According to Embodiment

The contents of the halftone process that is performed during the image printing process shown in FIG. 10 will now be described. The halftone process according to this embodiment is based on a method that is referred to as a so-called dither method. Accordingly, before describing the halftone process according to this embodiment in detail, a general dither method will be simply described.

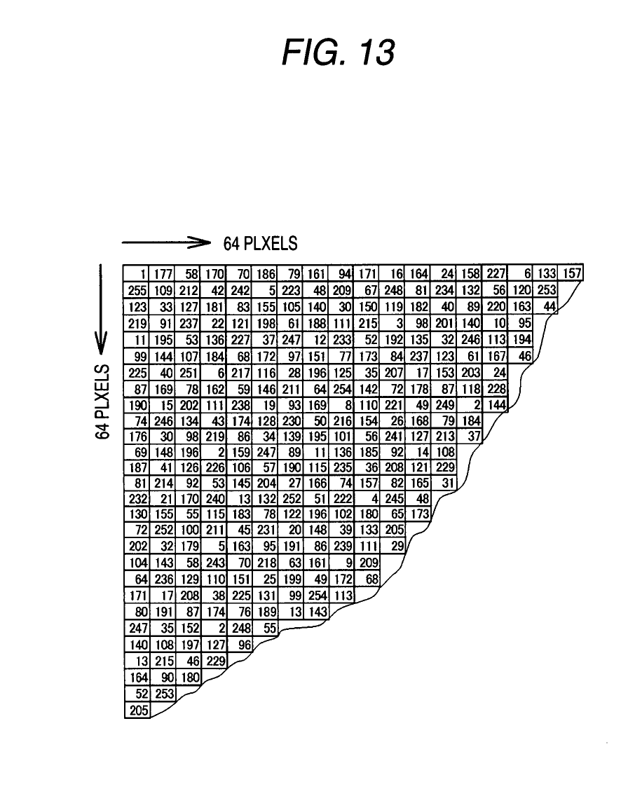

FIG. 13 is a diagram illustrating an enlarged portion of a dither matrix. In the dither matrix shown in FIG. 13, threshold values, which are evenly selected from a range of grayscale values 0 to 255, are randomly stored in the pixels of the horizontal 64 □ the longitudinal 64, that is, 4096 pixels in total. In this case, the grayscale values of the threshold values being selected from the range of 0 to 255 means that in this embodiment, the CMYK image data is data of one byte and the threshold values obtain values in a range of 0 to 225. Further, the size of the dither matrix is not limited to a size of 64 pixels in a horizontal direction and 64 pixels in a longitudinal direction, as exemplified in FIG. 13. That is, the number of pixels in the horizontal and longitudinal directions in the dither matrix may be different from each other, and the size of the dither matrix may be set to various sizes.

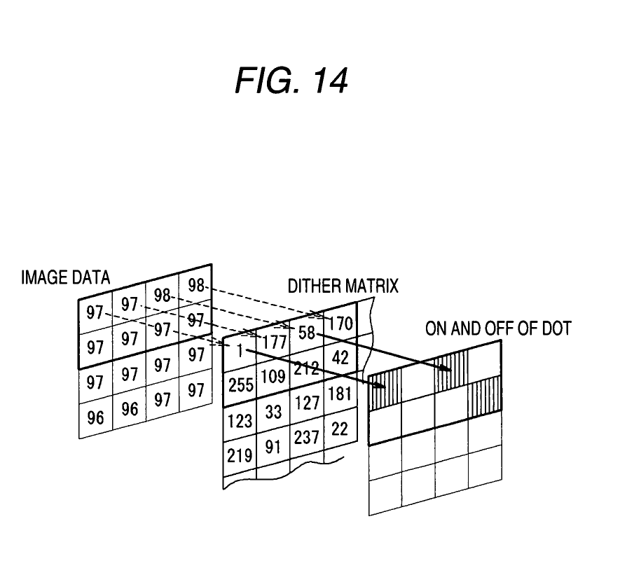

FIG. 14 is a diagram conceptually illustrating an aspect where whether a dot is formed for every pixel on the basis of a dither matrix. This determination is performed with respect to the respective colors including C, M, Y, and K. However, in the description below, in order to avoid the description from being complicated, the CMYK image data is referred to as image data without discriminating the respective colors of the CMYK image data.

When it is determined whether the dot is formed or not, first, a grayscale value of image data for a pixel considered as a determination target (attention pixel) is compared with a threshold value stored in a corresponding location in the dither matrix. The broken-line arrows shown in FIG. 14 schematically indicates a state where the image data of the attention pixel is compared with the threshold value stored in the corresponding location in the dither matrix. When a grayscale value of the image data of the attention pixel is larger than the threshold value in the dither matrix, it is determined that the dot is formed in the corresponding attention pixel. In contrast, when the threshold value in the dither matrix is larger than the grayscale value of the image data of the attention pixel, it is determined that the dot is not formed in the corresponding attention pixel. In an example shown in FIG. 14, a grayscale value of image data of a pixel located at an upper left corner of an image is ‘97’, and a threshold value stored in a location corresponding to the pixel in the dither matrix is ‘1’. Accordingly, in regards to the pixel located at the upper left corner, since the grayscale value of the image data is larger than the threshold value in the dither matrix, it is determined that the dot is formed in the corresponding pixel. The solid-line arrows shown in FIG. 14 schematically indicates an aspect where it is determined that the dot is formed in the corresponding pixel and the determined result is written in a memory. Meanwhile, a grayscale value of image data of a pixel leftward adjacent to the pixel located at the upper left corner of the image is ‘97’, and a threshold value stored in a location corresponding to the pixel in the dither matrix is ‘177’. Accordingly, in regards to the pixel leftward adjacent to the pixel located at the upper left corner of the image, since the threshold value in the dither matrix is larger than the grayscale value of the image data, it is determined that the dot is not formed in the corresponding pixel. As such, the image data and the threshold value set in the dither matrix are compared with each other, which determines whether a dot is formed or not, for each pixel.

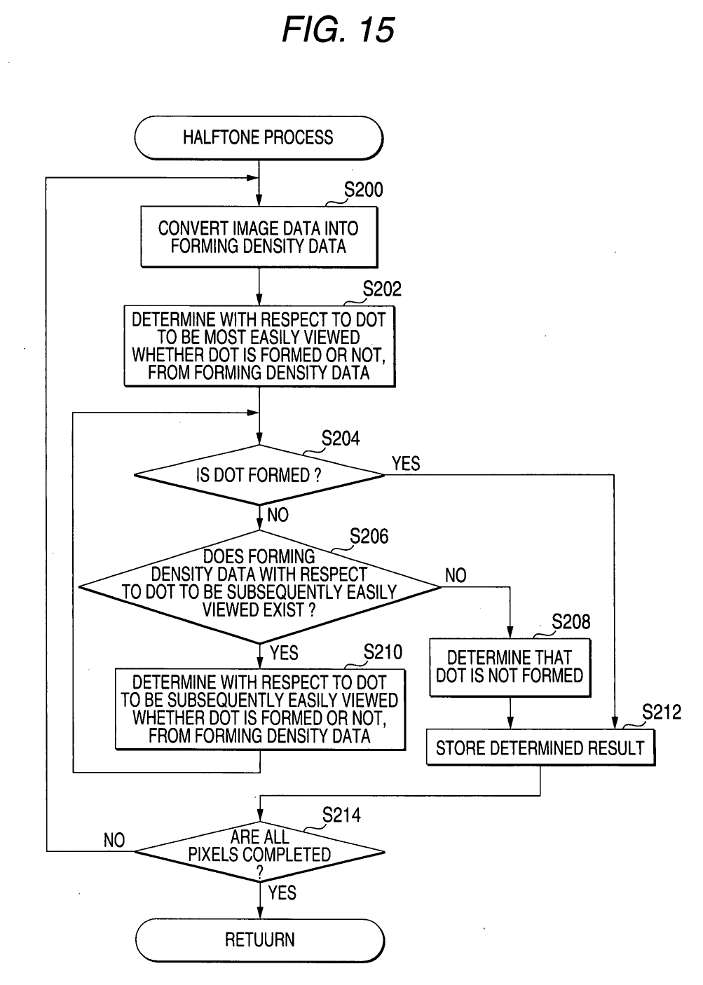

On the basis of the above-described contents, the halftone process according to this embodiment will be described. FIG. 15 is a flowchart illustrating a flow of a halftone process that is performed by a printing apparatus 10 according to this embodiment during an image printing process shown in FIG. 10. In the halftone process according to this embodiment, first, if the halftone process starts, the image data of the respective colors including C, M, Y, and K, which are obtained by the color conversion process, are converted into forming density data (Step S200). The forming density data is data that indicates the density of formed dots. The forming density data ‘0’ indicates information that all of the dots are not formed, and the forming density data ‘255’ indicates information that the dot is surely formed in the corresponding pixel. Further, the forming density data ‘128’ indicates information that the dot is formed in the corresponding pixel in almost half probability. As described above with reference to FIG. 12, in the printing apparatus 10 according to this embodiment, in regards to the Y dot and the K dot, three types of dots having different sizes are used and in regards to the C dot and the M dot, six types of dots including light dots are used, and the image is printed. Therefore, when the halftone process starts, first, the image data of the respective colors that is obtained by the color converting process is converted into the forming density data for the dots used in the respective colors. The process of converting the image data into the forming density data is performed on the basis of a predetermined forming density table.

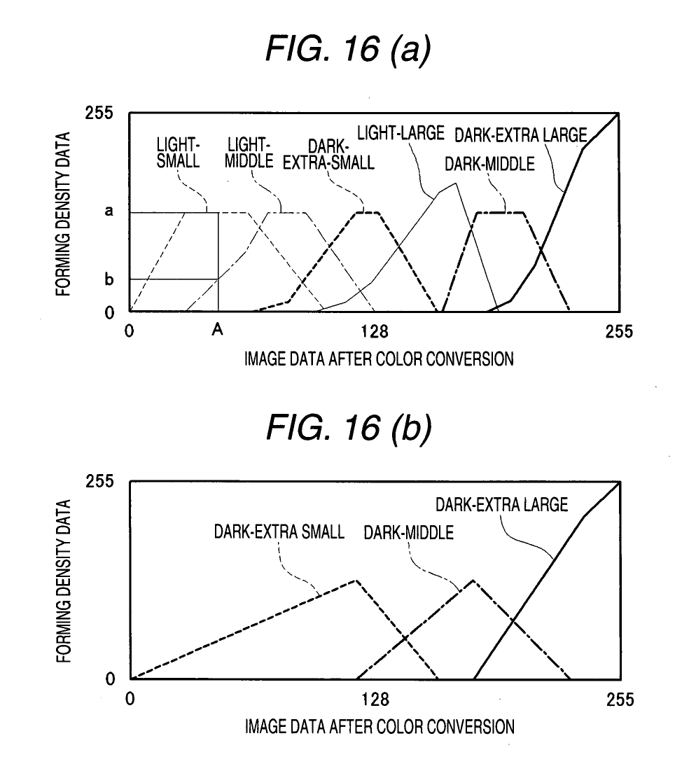

FIG. 16(a) is a diagram illustrating a forming density table that is used when converting image data of a C color and image data of an M color into forming density data. FIG. 16(b) is a diagram illustrating a forming density table that is used when converting image data of a Y color and image data of a K color into forming density data. For example, the C color is exemplified. As shown in FIG. 12, in regards to the dots of the C color, in addition to an extra small dot by a dark ink (hereinafter, referred to as dark-extra small dot), a middle dot by a dark ink (hereinafter, referred to as dark-middle dot), and an extra large dot by a dark ink (hereinafter, referred to as dark-extra large dot), a small dot by a light ink (hereinafter, referred to as light-small dot), a middle dot by a light ink (hereinafter, referred to as light-middle dot), and a large dot by a light ink (hereinafter, referred to as light-large dot, that is, dots of six types in total are used. In order to correspond to the above, as shown in FIG. 16(a), in the forming density table for a C color, the dot forming density is set with respect to the image data. For example, in regards to the grayscale value A of the image data, forming density data of a light-small dot is set to ‘a’, forming density data of a light-middle dot is set to ‘b’, and forming density data of each of the other dots is set to ‘0’. Accordingly, if using the forming density data, with respect to the image data after the color conversion process is performed, it is possible to obtain whether which types of dots are generated with which degree of density.

Further, in regards to the Y dot and the K dot, three types of dots including a dark-small dot, a dark-middle dot, and a dark-large dot are only used. As shown in FIG. 16(b), in the forming density tables for a Y color and a K color, forming density data for these three types of dots is set. Even in regards to the Y color and the K color, it is possible to obtain whether which types of dots are generated with which degree of density by referring to the color conversion table from the image data after the color converting process is performed. In step S200 of the halftone process shown in FIG. 15, as described above, on the basis of the forming density table, a process is performed for converting the image data after the color conversion into forming density data of various dots.

Next, the dither method is applied to the forming density data obtained in this way, and it is determined whether various dots are formed or not. In this case, when forming density data for a plurality of types of data is obtained, the determination whether dot is formed or not starts from the most easily viewed dot. For example, as shown in FIG. 16(a), in regards to the grayscale value A of the image data, forming density data is obtained with respect to two types of dots including a light-small dot and a light-middle dot. However, since the light-middle dot rather than the light-small dot is easily viewed, first, it is determined with respect to the light-middle dot where the dot is formed or not. The reason why the determining of whether the dot is formed or not in the order is performed is as follows. When forming two types of dots including a dot (for example, small dot) to be not easily viewed and a dot (for example, large dot) to be easily viewed, if these dots are formed to overlap each other, the dot to be difficult to be viewed is shielded by the dot to be easily viewed, and the forming of the dot to be difficult to be viewed becomes meaningless. For this reason, the dot to be not easily viewed and the dot to be easily viewed need to be formed not to overlap each other. Accordingly, in order that with respect to the dots on which a determination of whether a dot is formed or not is performed late, the corresponding dots are not formed to overlap the same pixel, it is determined whether the dot is formed or not, in a state where the pixels in which the dots are previously formed are avoided.

From the above description, the following points are apprehended. That is, when the plurality of types of dots are formed, with respect to the dots on which a determination of whether the dots are formed or not is performed early, it can be determined whether the corresponding dots are formed or not, such that the dots are optimally dispersed. However, with respect to the dots on which a determination of whether the dots are formed or not is performed late, the determination of whether the dots are formed or not should be performed in a state of avoiding the pixels in which the dots are previously formed. For this reason, with respect to the dots on which a determination of whether the dots are formed or not is performed late, the dots may not be optimally dispersed. In regards to the dots to be easily viewed, if the corresponding dots are not optimally dispersed, the image quality becomes deteriorated. Accordingly, when it is determined with respect to the plurality of types of dots whether the corresponding dots are formed or not while the dither method is used, the determination is performed sequentially from the dots to be easily viewed.

The determination on whether the dot is formed or not is performed using the method having been described with reference to FIGS. 13 and 14. That is, the grayscale value of the forming density data and the threshold value in the dither matrix are compared with each other. At this time, when the grayscale value of the forming density data is larger than the threshold value in the dither matrix, it is determined that the dot is formed in the corresponding pixel, and when the grayscale value of the forming density data is smaller than the threshold value in the dither matrix, it is determined that the dot is not formed in the corresponding pixel. In step S202 of FIG. 15, with respect to the dot to be most easily viewed among the forming density data that is obtained on the basis of the forming density table, a process of determining whether the dot is formed or not is performed, as described above.

Then, it is determined whether the dot is formed in the attention pixel (Step S204). In this case, it is determined only with respect to the dot to be most easily viewed whether the dot is formed or not. However, as described above, as the result of the application of the dither method, when it is determined that the dot is formed, it is determined as ‘yes’ in step S204, and the result of determination on whether the dot is formed or not is stored (Step S212). Meanwhile, when it is determined that the dot to be most easily viewed is not formed, it is determined as ‘no’ in step S204, and the process of determination with respect to the other dots on whether the dots are formed or not starts.

As described above, in the dither method, according to a request on image quality, the determination on whether the dot is formed or not is performed sequentially from the dots to be easily viewed. Therefore, with respect to the pixel which has been determined that the most easily viewed dot is not formed, it is determined whether the forming density data of the subsequently easily viewed dot exits or not (Step S206). For example, as shown in FIG. 16(a), in regards to the grayscale value A of the image data, in addition to the forming density data ‘b’ of the light-middle dot, the forming density data ‘a’ of the light-small dot is obtained. Therefore, it is determined that the forming density data exists (Step S206: yes), and it is determined with respect to the corresponding dot whether the dot is formed or not (Step S210).

The determination on whether the dot is formed or not in step S210 is performed as follows. First, the forming density data (in this case, ‘b’) of the dot (in this case, light-middle dot) having been determined that the dot is not formed with respect to the corresponding pixel is added to the forming density data (in this case, ‘a’) of the target dot (in this case, light-small dot). Then, the added value to be obtained is compared with the threshold value in the dither matrix. At this time, when the added value is larger than the threshold value, it is determined that the target dot is formed. In contrast, when the added value is smaller than the threshold value, it is determined that the target dot is not formed.

In this way, if the determination with respect to the target dot (in this case, light-small dot) on whether the dot is formed or not is performed, the process returns to step S204, and it is determined whether the dot is formed in the corresponding pixel. Then, when it is determined that the light-small dot is formed (Step S204: yes), the determined result is stored (Step S212). Meanwhile, when it is determined that the dot is not formed (Step S204: no), it is determined whether the forming density data for the subsequently easily viewed dot exits or not (Step S206). In this case, since the forming density data is obtained only with respect to the two types of dots including the light-middle dot and the light-small dot, the forming density data of the subsequently easily viewed dot does not exit (Step S206: no). After all, it is determined that the dot does not exit in the corresponding pixel (Step S208), and the determined result is stored (Step S212).

In this case, the description has been given of the case where the forming density data is obtained only with respect to the two types of dots. In the case where the forming density data of more than the three types of dots is obtained, even when the determination process in Step S206 is performed twice, the forming density data of the third dot remains. Accordingly, in this case, it is determined with respect to the third dot whether the dot is formed or not (Step S210). Since it is already determined with respect to the two types of dots that the dots are not formed in the corresponding pixels, the forming density data of these dots is added to the forming density data of the dot where the determination on whether the dot is formed or not now starts, the dither method is applied to the added value to be obtained, and it is determined whether the dot is formed or not.

As described until now, in the halftone process according to this embodiment, after the image data is converted into the forming density data, the dither method is applied sequentially from the dots to be easily viewed, and thus it is determined whether the dot is formed or not. Even though it is determined that any dot is formed (Step S204: yes) or the determination is made on all of the dots, when it is not determined that the dot is formed in any pixel (Step S206), it is determined that the dot is not formed in the pixel. In addition, after the determined result having been obtained is stored, (Step S212), it is determined whether the above-described process is performed on all of the pixels of the image (Step S214). As a result, when it is determined that the non-processed pixels remain (Step S214, no), the process returns to step S200, and the above-described series of processes are performed on the non-processed pixels. While the series of processes are being repeated, if it is determined that the process is completed on all of the pixels (Step S214, yes), the halftone process shown in FIG. 15 is completed, and the process returns to the image printing process shown in FIG. 10.

In the image printing process shown in FIG. 10, after the interlace process is performed on the halftone process result obtained in the above-described manner (Step S108), the dot data is supplied to the ink ejecting heads 244 to 249 of the respective colors so as to form the dots. As a result, the image is printed.

In this case, as shown in FIGS. 16(a) and 16(b), in the forming density table for the C color and the M color, the forming density data is set with respect to the respective dots including the light-small dot, the light-middle dot, the dark-extra small dot, the light-large dot, the dark-middle dot, and the dark-extra large dot. Accordingly, if it is determined with respect to various dots whether the dots are formed or not on the basis of the forming density data that is obtained by referring to the table, when printing a so-called gradation image becoming gradually dark from a bright image, first, the light-small dot is formed, and as the image becomes dark, the dot is changed in the order of the light-middle dot, the dark-extra small dot, the light-large dot, and the dark-middle dot. Finally, the dark-extra large dot is formed. In this way, the image can be printed.

Of course, if the extra small dot or the extra large dot can be formed by the dark ink, the extra small dot or the extra large dot can be formed by the light ink. Similarly, if the small dot and the large dot can be formed by the light ink, these dots can be formed by the dark ink. However, in the printing apparatus 10 according to this embodiment, the image is printed without using the dots, and thus the image can be effectively printed in the following points. First, if the types of dots to be formed are increased, the types of the dots formed to print the image are frequently changed, which causes the image quality to be deteriorated. That is, if the types of the dots are increased, the image quality is not improved. Further, if the types of the dots are increased, since the halftone process or the interlace process becomes complicated, a large amount of process time is required, and it becomes difficult to fast print the image. In addition, the result of the halftone process needs to be stored for each of the types of the dots, which increases a memory capacity required when storing the halftone process result. In view of these points, it is not preferable that the types of the dots be increased. Accordingly, it is preferable that the dots to be effectively used be selected from among the types of the dots that can be formed.

From this point of view, the extra small dot by the light ink is not viewed. For this reason, even though the extra small dot is formed, since there little variation in the extra small dot, the extra small dot by the light ink is a dot whose utility value is relatively low. Further, since the extra large dot is used when printing a painting-out image referred to as a so-called solid image, a character, or the like, it is generally formed by the dark ink. Therefore, the extra large dot by the light ink is a dot whose utility value is relatively low. Accordingly, these dots are set to dots not to be used, and thus the image can be printed in a state where the sufficiently high image quality is maintained.

Further, as the dots by the light ink, there are three types of dots, that is, the small dot, the middle dot, and the large dot. Thus, in order to match the types of the dots by the dark ink with the types of the dots by the light ink, the types of the dots by the dark ink are set to three types, that is, the extra small dot, the middle dot, and the extra large dot. In this case, with respect to both the light dots and the dark dots, the types of dots can be specified by two bits. If the types of dots by the dark ink are set to the four types, three bits are required in specifying the types of dots, and thus a data mount may be increased by 1.5 times. In regards to the light dot and the dark dot, the types of dots are set to the three types. As a result, the plurality of types of dots can be formed and the image can be printed without increasing the data amount.

The printing apparatus according to this embodiment has been described. However, the invention is not limited thereto, and various changes and modifications can be made without departing from the spirit and scope of the invention.

What is claimed is:

1. A printing apparatus operable to print an image by forming first dots with first ink having a first density and second dots with second ink having a second density lower than the first density, the printing apparatus comprising:
a first dot former operable to form a plurality of sizes of the first dots; and
a second dot former operable to form a plurality of sizes of the second dots, wherein:
a smallest one of the sizes of the first dots is smaller than a smallest one of the sizes of the second dots; and
a largest one of the sizes of the first dots is larger than a largest one of the sizes of the second dots.

2. The printing apparatus as set forth in claim 1, wherein:
the first dot former is operable to form three sizes of the first dots; and
the second dot former is operable to form three sizes of the second dots.

3. The printing apparatus as set forth in claim 1, wherein:
each of the sizes of the first dots is different from each of the sizes of the second dots.

4. An image processing apparatus operable to generate control data adapted to be used in a printing apparatus which is operable to print an image by forming first dots with first ink having a first density and second dots with second ink having a second density lower than the first density, by performing a predetermined image process on image data of the image, the image processing apparatus comprising:
a first dot formation judge operable to judge whether the first dots having one of a plurality of sizes are formed or not, based on the image data;
a second dot formation judge operable to judge whether the second dots having one of a plurality of sizes are formed or not, based on the image data; and
a control data generator operable to generate the control data based on judgments of the first dot formation judge and the second dot formation judge, wherein:
a smallest one of the sizes of the first dots is smaller than a smallest one of the sizes of the second dots; and
a largest one of the sizes of the first dots is larger than a largest one of the sizes of the second dots.

5. A printing method for printing an image by forming first dots with first ink having a first density and second dots with second ink having a second density lower than the first density, the printing method comprising:
forming a plurality of sizes of the first dots; and
forming a plurality of sizes of the second dots, wherein:
a smallest one of the sizes of the first dots is smaller than a smallest one of the sizes of the second dots; and
a largest one of the sizes of the first dots is larger than a largest one of the sizes of the second dots.
